(19) United States
(12) Patent Application Publication
(10) Pub. No.: US 2015/0352567 A1
(43) Pub. Date: Dec. 10, 2015

(54) COMPRESSED GAS PREPARATION SYSTEM AND COMPRESSED-GAS OPERATED COATING INSTALLATION

(71) Applicant: Thomas MAYER, Altheim (DE)

(72) Inventor: Thomas MAYER, Altheim (DE)

(21) Appl. No.: 14/740,591

(22) Filed: Jun. 16, 2015

Related U.S. Application Data
(63) Continuation of application No. PCT/EP2013/003896, filed on Dec. 20, 2013.

(30) Foreign Application Priority Data
Dec. 20, 2012 (DE) 20 2012 012 185.5

(51) Int. Cl. B05B 5/03; B05B 7/24; B05B 13/04; B05B 7/08

(52) U.S. Cl. CPC B05B 5/03; B05B 7/0815; B05B 7/2491; B05B 13/0431

(57) ABSTRACT

A compressed-gas preparation system for compressed-gas-operated coating installations, comprising a compressed-gas source, a supply station, at least one spray head and at least one high-voltage device, wherein the high-voltage device comprises a discharge chamber, a high-voltage discharge device and a high-voltage generator, characterized in that the high-voltage device is arranged outside the supply station, and in that the high-voltage device is connected downstream of the supply station in the stream of the compressed gas.

### FIELD OF THE INVENTION

The invention relates to a compressed-gas preparation system for compressed-gas-operated coating installations and to a compressed-gas-operated coating installation.

### BACKGROUND OF THE INVENTION

A compressed-gas preparation system is known from DE 10 2011 011 054 A1. Said compressed-gas preparation system for compressed-gas-operated coating installations comprises a compressed-gas source, a supply station, a spray head and an ionization device installed in the supply station, wherein the ionization device comprises a discharge chamber, a high-voltage discharge device and a high-voltage generator. It has been shown that treatment of compressed gases with high voltage has a considerable influence on the flow properties and application results of the treated compressed gases in painting technology. It may be insignificant here whether the high-voltage treatment of the compressed gas brings about ionization, electric charging or possibly even a phase transition into a non-thermal plasma phase, depending on which properties are intended to be influenced or achieved. However, when a long feed line to the spray head is used, the effect, for example, the degree of ionization of the compressed gas, drops below the desired level.

### SUMMARY OF THE INVENTION

The invention is based on the object of developing a compressed-gas preparation system or a compressed-gas-operated coating installation, which compressed-gas preparation system or coating installation is also suitable for operation with a long feed lines between the supply station and the spray head.

The essence of the invention consists in accommodating a high-voltage device, in particular ionization device, in the compressed-gas train of a compressed-gas source and connected downstream of the supply station associated therewith, in order to provide the advantageous effect described as close as possible to a color/coating-applying spray head.

In the compressed-gas preparation system according to the invention for compressed-gas-operated coating installations, the high-voltage device, in particular ionization device, is arranged outside the supply station, and the ionization device is connected downstream of the supply station in the compressed-gas stream. By this means, it is possible to ensure the respectively required maximum distance between the spray head and the high-voltage device, in particular ionization device, irrespective of the length a feed line and thus also to ensure the quality of the spraying result.

Compressed gases within the context of the invention should be understood as meaning the same technical gases which are used in the color application or painting technology or coating technology (also powder coating technology).

It is essential for the invention that the effect is not brought about by electrostatic neutralization of the compressed gases used, but rather that the flow properties and the transport properties are actually influenced by the high-voltage electromagnetic field which is passed through.

Furthermore, in order to use the compressed-gas preparation system in an explosion-protected painting space of the coating installation, the invention makes provision to arrange the high-voltage generator of the high-voltage device, in particular ionization device, outside the explosion-protected painting space, and to arrange the discharge chamber and the high-voltage discharge device of the high-voltage device, in particular ionization device, within the explosion-protected painting space, wherein the high-voltage generator is connected to the high-voltage discharge device by electric cables. In the case of such an arrangement of components, it is possible to use a conventional, non-explosion-protected and therefore cost-effective high-voltage generator although the discharge chamber and the high-voltage discharge device are arranged in the explosion-protected painting space.

Alternatively, in order to use the compressed-gas preparation system in an explosion-protected painting space, the invention also makes provision to arrange the discharge chamber, the high-voltage discharge device and the high-voltage generator of the high-voltage device, in particular ionization device, within the explosion-protected painting space, wherein the high-voltage generator is designed as an explosion-protected high-voltage generator. Such an arrangement is constructed in a simple manner and can be installed or moved as a compact unit in particular in the explosion-protected painting space.

Furthermore, the invention makes provision either to form an assembly by means of the discharge chamber and the high-voltage discharge device or to form an assembly by means of the discharge chamber, the high-voltage discharge device and the high-voltage generator, wherein the respectively formed assembly is either integrated in the spray head or is arranged on a manipulator, by which the spray head is guided, wherein the assembly in the event of arrangement on the manipulator is arranged in particular on a component which moves during operation, in particular an arm of the manipulator, or is arranged in a positionally fixed manner in the explosion-protected painting component. Arrangements of this type can be adapted in a simple manner to the respective requirement.

The invention also makes provision to arrange a filter device and/or a heating device for the compressed gas upstream of the high-voltage device, in particular ionization device, wherein the filter device and/or the heating device is or are arranged outside the explosion-protected painting space and in particular in the supply station, or the filter device and/or the heating device is or are arranged within the explosion-protected space and outside the supply station. The quality of the compressed gas can thereby be further increased.

According to a variant embodiment of the invention, it is provided, in order to use the compressed-gas preparation system as a wet painting installation or as a powder coating installation, to form the coating installation with a wet painting space or coating space, wherein either the discharge chamber, the high-voltage discharge device and the high-voltage generator of the high-voltage device, in particular ionization device, form a common assembly, or wherein exclusively the discharge chamber and the high-voltage discharge device of the high-voltage device, in particular ionization device, form a common assembly, wherein the assembly formed is arranged in the painting space or coating space in such a manner that said assembly is either connected via a first feed line section to the supply chamber and via a second feed line section to the spray head, or in that the assembly formed is integrated in the spray head. Arrangements of this type can be adapted in a simple manner to the respective requirements.

According to the invention, the assembly formed is either arranged on a manipulator, by which the spray head is guided, wherein the assembly in the event of arrangement on the manipulator is arranged in particular on a component which moves during operation, in particular an arm of the manipulator, or the assembly formed is arranged in a positionally fixed manner in the painting space or coating space. It is thereby possible to equip the installation in a manner meeting requirements.

In the case of the installation used as a wet painting installation or as a powder coating installation, a filter device and/or a heating device is connected upstream of the high-voltage device, in particular ionization device, wherein the filter device and/or the heating device either is or are arranged in the supply station or is or are arranged between the supply station and the high-voltage device, in particular ionization device. The quality of the compressed gas can thereby be further increased.

The invention also makes provision to dimension the feed line section which connects the high-voltage device, in particular ionization device, and the spray head with a length of at most 2.5 m and in particular at most 0.5 m and to design the flow passage of said feed line section to be in particular free of metallic inserts, such as, in particular, valves and/or pressure reducers. This opposes an undesirable reduction in the degree of ionization of the compressed gas.

The invention makes provision to operate the compressed-gas preparation system either as a compressed-air preparation system which is operated with air, or to operate same as a nitrogen preparation system which is operated with nitrogen, or to operate same as an air and nitrogen preparation system which is operated with a nitrogen and air mixture. By this means, the advantages emerging from the invention are usable in all three types of system.

The compressed-gas-operated coating installation according to the invention, which is designed as a painting installation, comprises a compressed-gas preparation system as claimed in claim 1 and in addition in particular at least one of claim 2 to 5 or 10 and therefore also has the advantages thereof.

The compressed-gas-operated coating installation according to the invention, which is designed as a wet painting installation or powder coating installation, comprises a compressed-gas preparation system as claimed in claim 6 and in addition in particular at least one of claims 7 to 10 and therefore also the advantages thereof.

Within the context of the invention, a supply station is understood as meaning a compressed-gas treatment device and/or compressed-gas regulation device, wherein the supply station is formed in particular by an arrangement, such as, in particular, a cabinet or a container, which cabinet or which container has a flange for the connection of a feed line for a spray head. In this connection, a supply station of this type is supplied with compressed gas from a compressed-gas source, and wherein the supply station comprises in particular a pressure reducer and/or a filter device for the compressed gas and/or a heating device for the compressed gas. The pressure reducer and/or the filter device and/or the heating device can also be arranged here separated structurally from one another. In the smallest construction stage, the compressed-gas treatment device and/or compressed-gas regulation device comprises only a pressure reducer and/or a filter device for the compressed gas and/or a heating device for the compressed gas.

Within the context of the invention, a powder paint is understood as meaning in particular also a powder enamel paint, and a wet paint is understood as meaning in particular also wet enamel paint.

Within the context of the invention, a manipulator is understood as meaning both a robot with a plurality of movement axes and a fixedly installed or movable lifting framework. In this connection, the spray head or the spray heads is or are either connected fixedly to the lifting framework and are automatically moved with the latter, or the spray head or the spray heads is or are guided manually by a person located on the lifting framework.

Further details of the invention are described in the drawing with reference to schematically illustrated exemplary embodiments. A high-voltage apparatus, in particular ionization apparatus, is referred to in the following exemplary embodiment exclusively as an ionization device, but is not restricted to this embodiment. In equivalent embodiments the ionization device can be replaced by pure high-voltage alternating field treatment or a high-voltage chamber for generating a non-thermal plasma state.

### BRIEF DESCRIPTION OF THE DRAWINGS

In this connection:

FIG. 1 shows a schematic view of a first variant embodiment of a compressed-gas preparation system;

FIG. 2 shows a schematic view of a second variant embodiment of a compressed-gas preparation system;

FIG. 3 shows a sectioned view of an ionization device with a high-voltage discharge apparatus;

FIG. 4 shows a sectioned view of an ionization device with two high-voltage discharge apparatuses, and

FIGS. 5 to 11 show schematic views of a third to eighth variant embodiment of a compressed-gas preparation system.

### DETAILED DESCRIPTION OF THE INVENTION

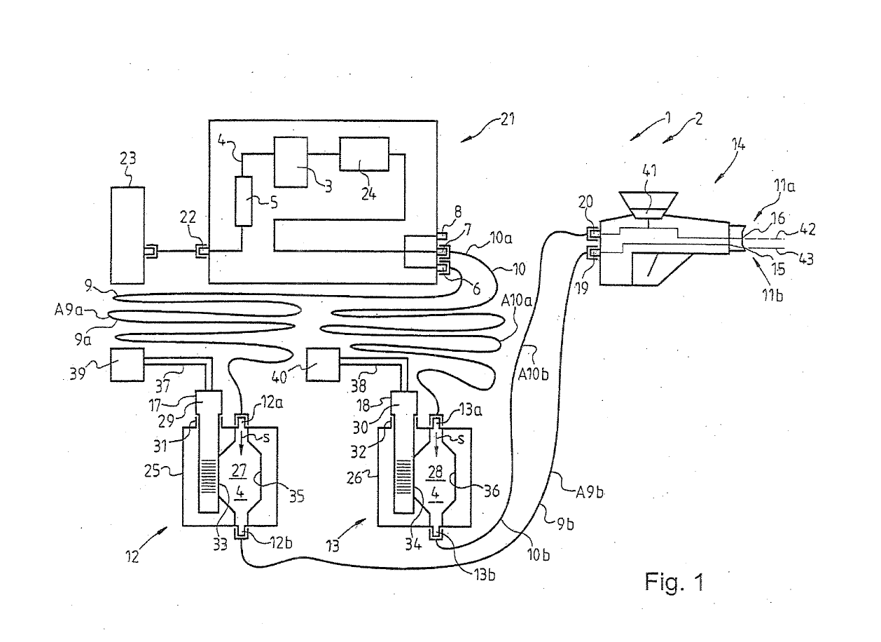

FIG. 1 illustrates, in a schematic view, a first variant embodiment of a compressed-gas preparation system 1 for compressed-gas-operated coating installations which are designed as painting installations 2. The compressed-gas preparation system 1 comprises a filter device 3 for cleaning and/or drying compressed gas 4, a pressure reducer 5, a first, second and third flange 6, 7, 8 for coupling feed lines 9, 10 for consumers 11a, 11b, a first and a second ionization device 12, 13, and a spray head 14. In the first variant embodiment and in all of the further variant embodiments, either air or nitrogen or a nitrogen and air mixture is used as the compressed gas. The spray head 14 has a first opening 15 for the outflow of compressed gas and a second opening 16 for the outflow of compressed gas and coloring matter, wherein the openings 15, 16 form the consumers 11a, 11b. The ionization devices 12, 13 each comprise a high-voltage discharge apparatus 17, 18 past which at least some of the compressed gas 4 flows. The feed lines 9, 10 here are of two-part design and in each case comprise a first feed line section 9a or 10a and a second feed line section 9b or 10b. The first feed line section 9a or 10a is arranged in each case between the mentioned flange 6 or 7 and first connections 12a or 13a of the ionization devices 12 or 13. The second feed line section 9b or 10b is arranged in each case between second connections 12b or 13b of the ionization devices 12 or 13 and flanges 19 or 20 of the spray head 14. The filter device 3 and the pressure reducer 5 are part of a supply station 21 which, in addition to the flanges 6, 7, 8 for dispensing compressed gas, also comprise a further flanges 22, via which the supply station 21 is fed with compressed gas from a compressed-gas source 23. The feed line sections 9a and 9b have lengths A9a and A9b. The feed line sections 10a and 10b have lengths A10a and A10b. The lengths A9b and A10b of the second feed sections 9b and 10b, which connect the ionization device 12, 13 to the spray head 14, are dimensioned in such a manner that a continuously sufficient degree of ionization of the compressed gas in the spray head 14 occurs in order to avoid quality fluctuations. According to a preferred variant embodiment, it is provided also to connect a heating device 24 into the compressed-gas stream in the supply station 21 in order to ensure a constant temperature of the compressed gas flowing to the ionization devices 12, 13. The two ionization devices 12, 13 each comprise a container 25, 26 in which a discharge chamber 27 or 28 is arranged, wherein the discharge chamber 27 or 28 has the compressed gas 4 flowing therethrough. Furthermore, the ionization devices 12, 13 in each case comprise an ionization bar 29 or 30 which forms the mentioned high-voltage discharge apparatus 17 or 18. The ionization bars 29, 30 here are in each case arranged in the containers 25 or 26 in such a manner by means of a third connection 31 or 32. The ionization bars in each case form a section 33 or 34 of a lateral surface 35 or 36 of the discharge chamber 27 or 28 and thus come directly into contact with the compressed gas 4 flowing through the discharge chambers 27 or 28 in the flow direction s. The ionization bars 29, 30 are in each case connected to high-voltage sources or high-voltage generators 39 or 40 via electric cables or multiwire line 37 or 38. In the spray device 14, coloring matter 41 is admixed with the ionized compressed gas, which is fed in via the second feed line section 10b, and therefore a color jet 42 is formed. The ionized compressed gas fed in via the second feed line section 9b flows through the spray device 14 and emerges from the latter as a pure compressed gas jet 43 in order to laterally delimit the color jet 42.

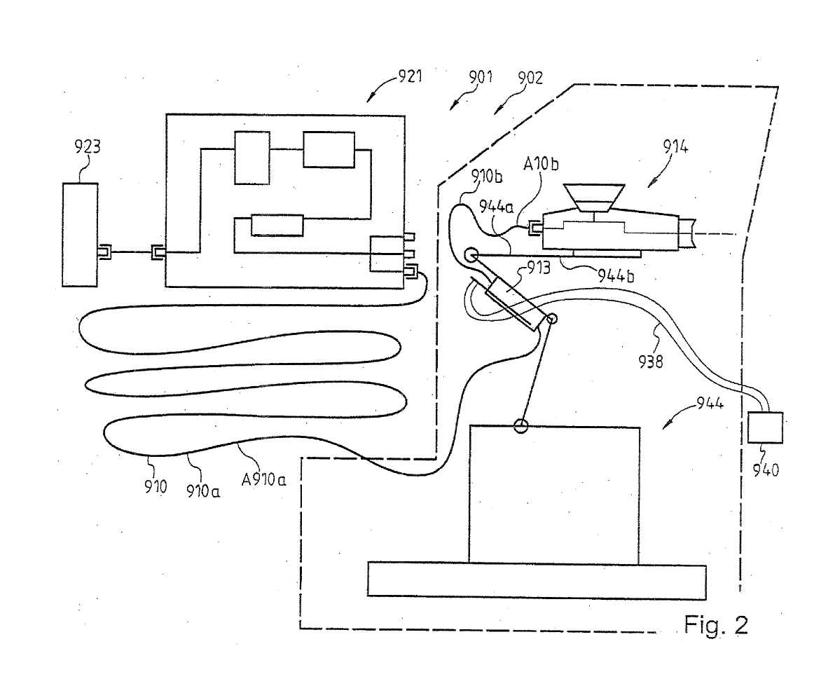

FIG. 2 illustrates, in a schematic view, a second variant embodiment of a compressed-gas preparation system 901 for compressed-gas-operated painting installations 902. With regard to the explanation of a supply station 921 and a compressed-gas source 923 feeding the latter, reference is made to the explanations regarding the first variant embodiment shown in FIG. 1. In contrast to the first variant embodiment, in the second variant embodiment, use is made of a spray head 914 which is connected to just one feed line 910. The spray head 914 is arranged on a first arm 944a of a manipulator 944 and is moved by the latter during painting work in a manner corresponding to the requirements. An ionization device 913 is arranged on a second arm 944b of the manipulator 944 in the vicinity of the spray head 914, and therefore a second feed line section 910b is dimensioned with a length A910b in all positions of the manipulator 944 sufficient in order to connect the spray head 914 and the ionization device 913 without restricting the freedom of movement. A first feed line section 910a which connects the supply device 921 to the ionization device 913 has a length A910a corresponding to the requirements and, by means of the length thereof, ensures that the manipulator 944 can move without restriction in a painting space 945. With regard to the construction of the ionization device 913, reference is likewise made to the description regarding FIG. 1. The ionization device 913 comprises a high-voltage generator 940 and is connected to the latter via a multiwire line 938. According to a variant embodiment which is not illustrated, the line 938 is guided parallel to the first feed line section 910a.

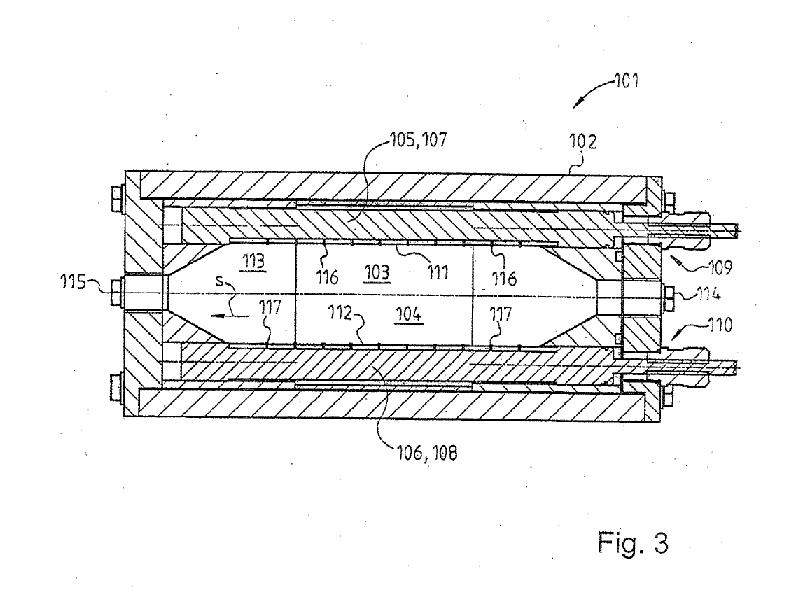

FIG. 3 shows a second ionization device 101 in a sectioned illustration. The ionization device 101 is used in the same manner as the first ionization devices shown in FIGS. 1 and 2. The ionization device 101 comprises a container 102 which has a discharge chamber 103, wherein compressed gas 104 flows through the discharge chamber 103. Furthermore, the ionization devices 101 comprises two ionization bars 105, 106 which form high-voltage discharge apparatuses 107, 108. The ionization bars 105, 106 are in each case pushable through a third and a fourth connection 109, 110 into the container 102 in such a manner that said sections 111, 112 form of a lateral surface 113 of the discharge chamber 103 and thus come directly into contact with the compressed gas 104 flowing in the flow direction s through the discharge chambers 103. The ionization bars 105, 106 are connected via multiwire lines (not illustrated) to a high-voltage generator (not illustrated). A first and a second feed line section of a feed line (not illustrated) are connected to first and second connections 114, 115. Electrodes 116, 117 of the ionization bars 105, 106 are in direct contact with the compressed gas 104.

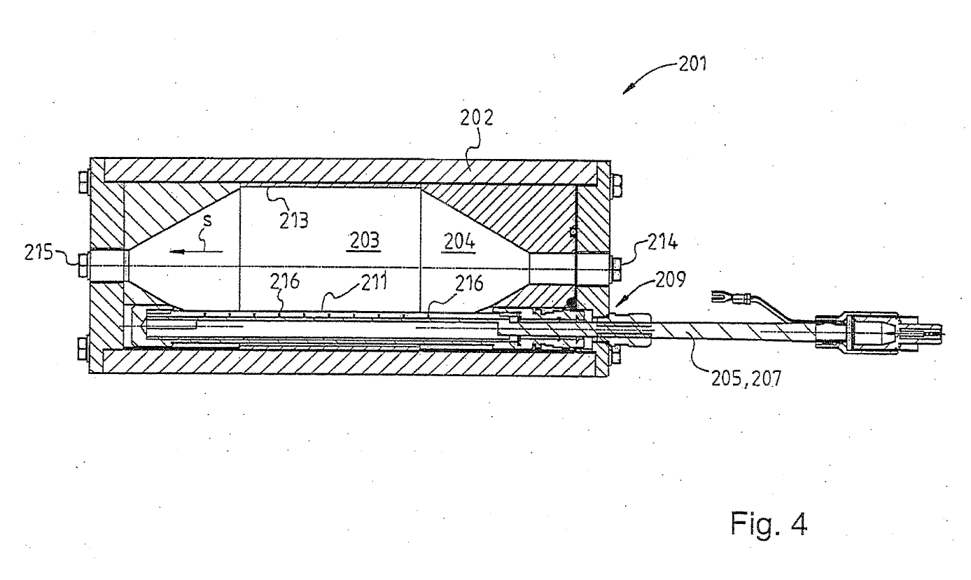

FIG. 4 shows a third ionization device 201 in a sectional illustration. The ionization device 201 is used in the same manner as the first ionization devices shown in FIGS. 1 and 2. The ionization device 201 comprises a container 202 which has a discharge chamber 203, wherein the compressed gas 204 flows through the discharge chamber 203. Furthermore, in contrast to the ionization device shown in FIG. 3, the ionization devices 201 comprises just one ionization bar 205 which forms a high-voltage discharge apparatus 207. The ionization bar 205 is pushable through a third connection 209 into the container 202 in such a manner that the latter forms a section 211 of a lateral surface 213 of the discharge chamber 203 and thus comes directly into contact with the compressed gas 204 flowing in the flow direction s through the discharge chambers 203. The ionization bar 205 is connected via a multiwire line (not illustrated) to a high-voltage generator (not illustrated). A first and a second feed line section of a feed line (not illustrated) are connected to first and second connections 214, 215. Electrodes 216 of the ionization bar 205 are in direct contact with the compressed gas 204.

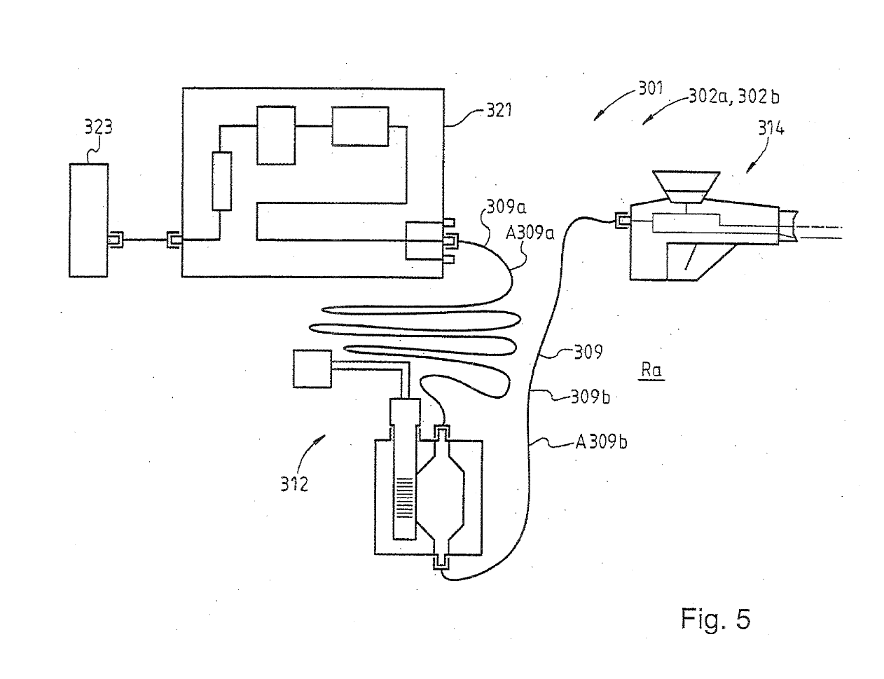

FIG. 5 schematically illustrates a third compressed-gas preparation system 301, wherein the latter is provided for a coating installation designed as a wet painting installation 302a or as a powder coating installation 302b. A supply station 321 and a compressed-gas source 323 and also an ionization device 312 are configured and arranged in a comparable manner to the arrangement according to FIG. 1. In this respect, reference is made to the description there. As in the exemplary embodiment shown in FIG. 1, a spray head 314 is operated in a non-explosion-protected space Ra, wherein the spray head 314 is supplied only via a feed line 309. The feed line 309 is of two-part design, wherein the ionization device 312 is connected between a first feed line section 309a having a length A309a and a second feed line section 309b having a length A309b, and the first feed line section 309a connects the supply station 321 to the ionization device 312.

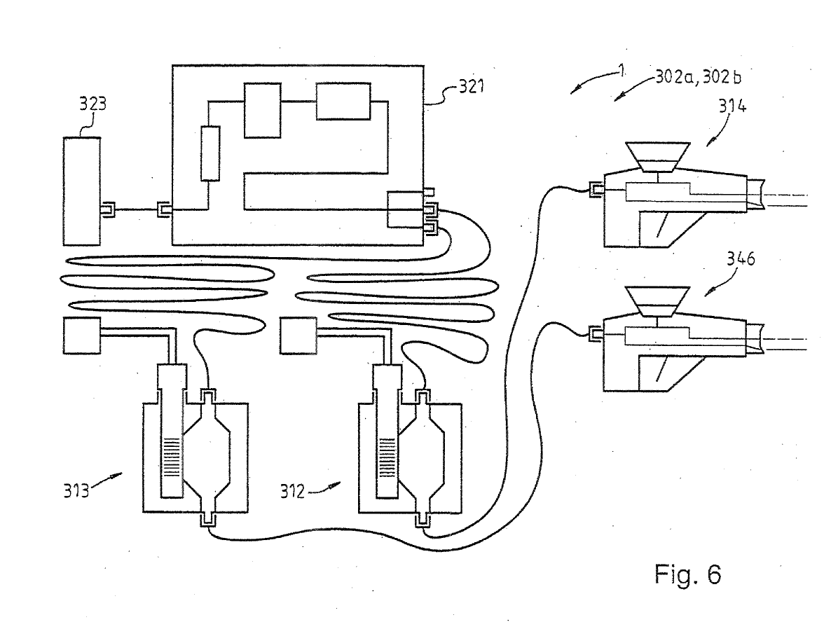

In FIG. 6, the third compressed-gas preparation system 301 described in FIG. 5 is additionally equipped with a second ionization device 313 which supplies a second spray head 346.

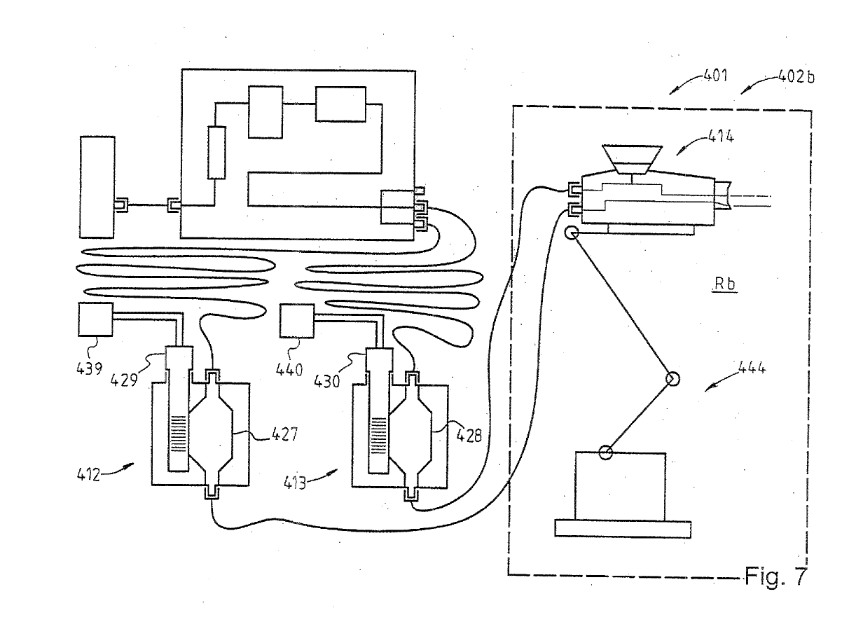

FIG. 7 shows, as a fourth variant embodiment, a compressed-gas preparation system 401, in which, for the supply of an explosion-protected painting installation 402b, ionization devices 412 and 413, with all of the components thereof, namely with an ionization bar 429 or 430, a discharge chamber 427 or 428 and a high-voltage generator 439 or 440, are arranged within an explosion-protected space or painting space Rb in which a spray head 414 guided by a manipulator 444 is located.

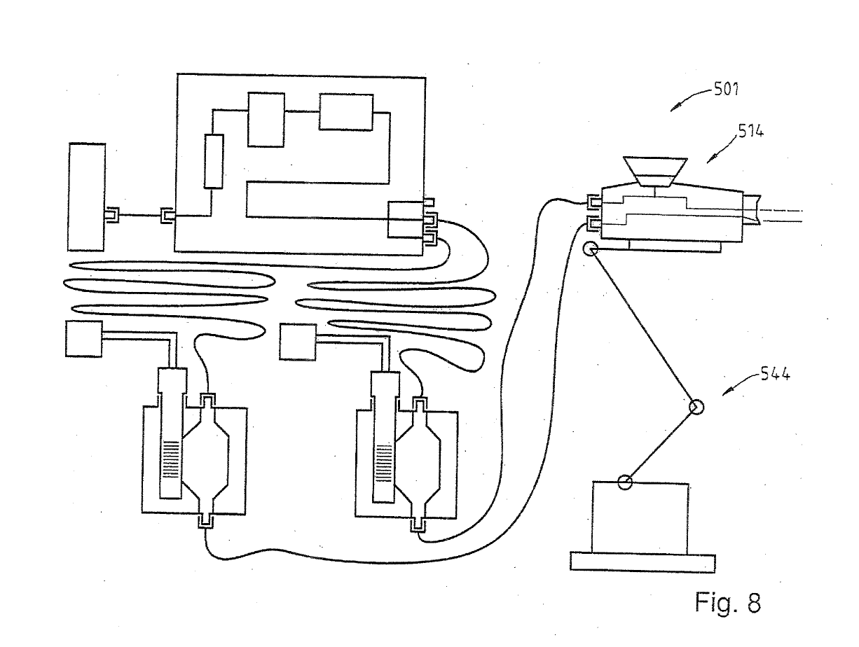

FIG. 8 shows, as a fifth variant embodiment, a compressed-gas preparation system 501 which is constructed analogously to the first variant embodiment shown in FIG. 1, wherein, in the fifth variant embodiment, a spray head 514 is guided by a manipulator 544.

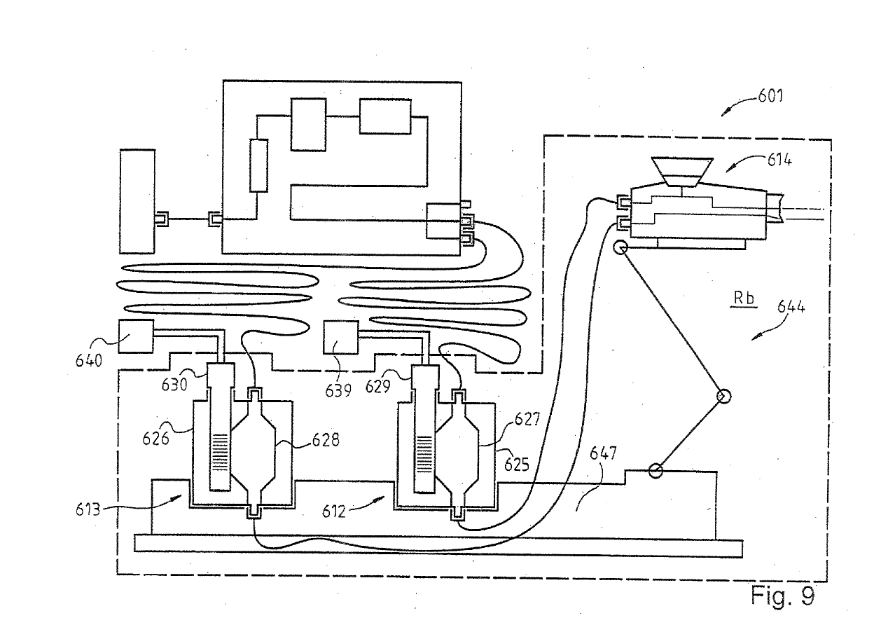

FIG. 9 shows, as a sixth variant embodiment, a compressed-gas preparation system 601 which is provided for operation in an explosion-protected space Rb, wherein ionization devices 612 and 613 with the components thereof, ionization bar 629 or 630 and discharge chamber 627 or 628, are located within the explosion-protected space Rb and only the high-voltage generators 639 and 640 thereof are arranged outside the explosion-protected space Rb. Containers 625, 626 in which the ionization bars and the discharge chambers are installed are arranged here on a fixed base 647 of a manipulator 644, by which a spray head 614 is guided.

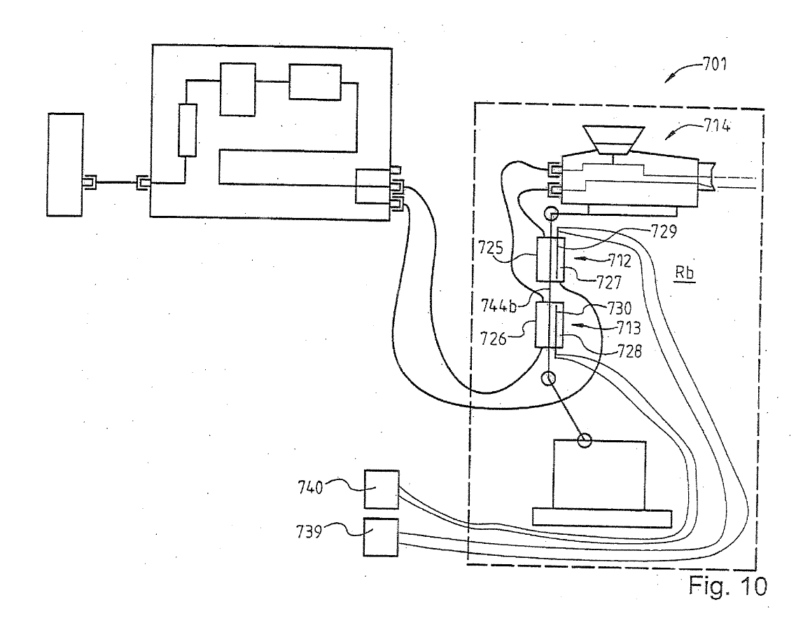

FIG. 10 shows, as a seventh variant embodiment, a compressed-gas preparation system 701 which is suitable for operation in an explosion-protected space Rb, wherein ionization devices 712 and 713 with the components thereof, ionization bar 729, 730 and discharge chamber 727, 728, are located within the explosion-protected space Rb and only the high-voltage generators 739, 740 thereof are arranged outside the explosion-protected space Rb. In contrast to the variant embodiment shown in FIG. 9, containers 725, 726 in which the ionization bars 729 or 730 and discharge chambers 727 or 728 are installed are arranged here on an arm 744b of a manipulator 744, by which a spray head 714 is guided.

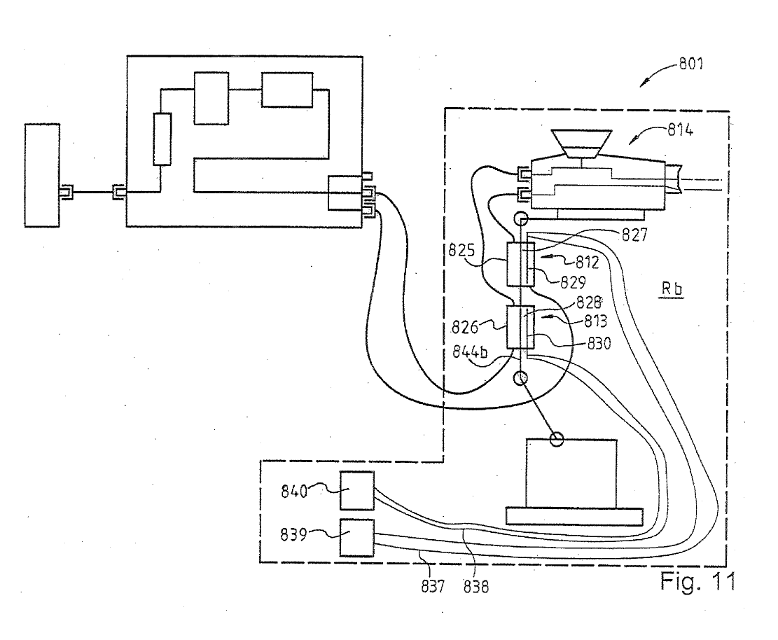

FIG. 11 shows, as an eighth variant embodiment, a compressed-gas preparation system 801 which is suitable for operation in an explosion-protected space Rb, wherein ionization devices 812 and 813 with all of the components thereof, namely an ionization bar 829 or 830, a discharge chamber 827 or 828 and a high-voltage generator 839 or 840, are located within the explosion-protected space Rb. Containers 825 or 826 in which the ionization bars 829 or 830 and discharge chambers 827 or 828 are installed are arranged here on an arm 844b of a manipulator 844, by which a spray head 814 is guided. The high-voltage generators 839, 840 are connected via electric cables or multiwire lines 837, 838 to the ionization bars 829, 830 and are arranged in a positionally fixed manner in the explosion-protected space Rb.

The invention is not restricted to exemplary embodiments illustrated or described. On the contrary, it comprises developments of the invention within the context of the claims.

### LIST OF REFERENCE SIGNS

1 Compressed-gas preparation system
2 Painting installation
3 Filter device
4 Compressed gas
5 Pressure reducer
6, 7, 8 Flange on 21
9, 10 Feed line
9a, 10a First feed line section of 9 or 10
9b, 10b Second feed line section of 9 or 10
11a, 11b Consumers for compressed gas
12, 13 Ionization device
12a, 13a First connection of 12 or 13
12b, 13b Second connection of 12 or 13
14 Spray head
15 First opening of 14
16 Second opening of 14
17, 18 High-voltage discharge apparatus
19, 20 Flange on 14
21 Supply station
22 Further flange on 21
23 Compressed-gas source
24 Heating device
25, 26 Container
27, 28 Discharge chamber
29, 30 Ionization bar
31, 32 Third connection
33, 34 Section of 35 or 36
35, 36 Lateral surface of 27 or 28
37, 38 Multiwire line or electric cable for 39, 40
39, 40 High-voltage generator
41 Coloring matter
42 Color jet
43 Compressed-gas jet
44 Manipulator
44a, 44b Arm of 44
45 Painting space
101 Ionization device
102 Container
103 Discharge chamber
104 Compressed gas
105, 106 Ionization bar
107, 108 High-voltage discharge apparatus
109, 110 Third, fourth connection on 102
111, 112 Section of 113
113 Lateral surface
114, 115 First, second connection on 102
116, 117 Electrode
201 Ionization device
202 Container
203 Discharge chamber
204 Compressed gas
205 Ionization bar
207 High-voltage discharge apparatus
209 Third connection on 202
211 Section of 213
213 Lateral surface
214, 215 First, second connection on 202
216 Electrode
301 Third compressed-gas preparation system
302a Wet painting installation
302b Powder coating installation 3
309 Feed line
309a First feed line section
309b Second feed line section
312 Ionization device
313 Second ionization device
314 Spray head
321 Supply station
323 Compressed-gas source
346 Second spray head
401 Compressed-gas preparation system
402b Explosion-protected painting installation
412, 413 Ionization device
414 Spray head
427, 428 Discharge chamber
429, 430 Ionization bar
439, 440 High-voltage generator
444 Manipulator
501 Compressed-gas preparation system
514 Spray head
544 Manipulator
601 Compressed-gas preparation system
612, 613 Ionization device
614 Spray head
625, 626 Container
629, 630 Ionization bar
639, 640 High-voltage generator
644 Manipulator
647 Fixed base
701 Compressed-gas preparation system
712, 713 Ionization device
714 Spray head
725, 726 Container
727, 728 Discharge chamber
729, 730 Ionization bar
739, 740 High-voltage generator
744 Manipulator
744b Arm
801 Compressed-gas preparation system
812, 813 Ionization device
814 Spray head
825, 826 Container
827, 828 Discharge chamber
829, 830 Ionization bar
837, 838 Multiwire line or electric cable
839, 840 High-voltage generator
844 Manipulator
844b Arm
901 Compressed-gas preparation system
902 Compressed-gas-operated painting installation
910 Feed line
910a First feed line section of 910
910b Second feed line section of 910
913 Ionization device
914 Spray head
921 Supply station
923 Compressed-gas source
938 Multiwire line
940 High-voltage generator
944 Manipulator
944a First arm of 944
944b Second arm of 944
945 Painting space
A9a, A10a Length of 9a or 10a
A9b, A10b Length of 9b or 10b
A309a Length of 309a
A309b Length of 309b
A910a Length of 910a
A910b Length of 910b
Ra Non-explosion-protected space
Rb Explosion-protected space or painting space
s Flow direction

1. A compressed-gas preparation system for compressed-gas-operated coating systems, comprising
a compressed-gas source,
a supply station,
at least one spray head,
at least one high-voltage device,
wherein the high-voltage device comprises a discharge chamber, a high-voltage discharge device and a high-voltage generator,
wherein the high-voltage device is arranged outside the supply station and in that the high-voltage device is connected downstream of the supply station in the stream of the compressed gas.

2. The compressed-gas preparation system as claimed in claim 1,
wherein in order to use the compressed-gas preparation system in an explosion-protected painting space of a coating installation, the high-voltage generator is arranged outside the explosion-protected painting space, and the discharge chamber and the high-voltage discharge device, are arranged within the explosion-protected painting space,
wherein the high-voltage generator is connected to the high-voltage discharge device by electric cables.

3. The compressed-gas preparation system as claimed in claim 1, wherein in order to use the compressed-gas preparation system in an explosion-protected painting chamber, the discharge chamber, the high-pressure discharge device and the high-voltage generator are arranged within the explosion-protected painting chamber, wherein the high-voltage generator is an explosion-protected high-voltage generator.

4. The compressed-gas preparation system as claimed in claim 2, wherein the discharge chamber and the high-voltage discharge device form a subassembly, or the discharge chamber and the high-voltage discharge device and the high-voltage generator form an assembly, wherein the respectively formed assembly
is integrated in the spray head, or
is arranged on a manipulator by which the spray head is guided,
wherein the assembly in the event of arrangement on the manipulator is arranged on a component which moves during operation, or is arranged in a positionally fixed manner in the explosion-protected painting space.

5. The compressed-gas preparation system as claimed in claim 1, further comprising:
at least one of a filter device and a heating device connected upstream of the high-voltage device,
wherein the filter device and the heating device arranged outside the explosion-protected painting space (Rb), or
wherein the filter device and the heating device are arranged within the explosion-protected painting space (Rb) and outside the supply station.

6. The compressed-gas preparation system as claimed in claim 1, wherein
in order to use the compressed-gas preparation system as a wet painting installation or as a powder coating installation, the coating installation is formed with a wet painting space or coating space,
wherein either the discharge chamber the high-voltage discharge device and the high-voltage generator form a common assembly, or
wherein the discharge chamber and the high-voltage discharge device of the high-voltage device form a common assembly,
wherein the assembly formed is arranged in the painting space or coating space in such a manner that said assembly
is either connected via a first feed line section to the supply station and via a second supply line section to the spray head, or
wherein the assembly formed is integrated in the spray head.

7. The compressed-gas preparation system as claimed in claim 6, wherein
the assembly formed is either arranged on a manipulator, by which the spray head is guided, wherein the assembly in the event of arrangement on the manipulator is arranged on a component which moves during operation, or
wherein the assembly formed is arranged in a positionally fixed manner in the painting space or coating space.

8. The compressed-gas preparation system as claimed in claim 6, further comprising:
at least one of a filter device and heating device arranged upstream of the high-voltage device, wherein the filter device and the heating device
either are arranged in the supply station,
or are arranged between the supply station and the ionization device.

9. The compressed-gas preparation system as claimed in claim 1, wherein the supply line section which connects the high-voltage device and the spray head has a length of at most 2.5 m, and wherein the flow passage of said supply line section is free of metallic inserts.

10. The compressed-gas preparation system as claimed in claim 1, wherein the compressed-gas preparation system is as a compressed-air preparation system and is operated with air, or the compressed-gas preparation system is a nitrogen preparation system and is operated with nitrogen, or the compressed-gas preparation system is an air and nitrogen preparation system and is operated with a nitrogen and air mixture.

11. A compressed-gas-operated painting installation, comprising an explosion-protected painting space, a compressed gas source and at least one spray head, wherein the installation comprises a compressed-gas preparation system as claimed in claim 1.

12. A compressed-gas-operated wet painting installation or powder coating installation, comprising a wet painting space or coating space, a compressed-gas source and at least one spray head, wherein the coating installation comprises a compressed-gas preparation system as claimed in claim 6.

13. The compressed-gas-operated installation as claimed in claim 12, wherein the wet painting space or the coating space is a non-explosion-protected space.

14. The compressed-gas preparation system as claimed in claim 1, wherein the high-voltage device is connected either by a first feed line section to the supply station and by a second feed line section to the spray head, or the high-voltage device is integrated in the spray head and is connected to the supply station by the feed line.

15. The compressed-gas preparation system as claimed in claim 1, wherein the high-voltage device is an ionization device.

16. The compressed-gas preparation system as claimed in claim 4, wherein the component which moves during operation is an arm of the manipulator.

17. The compressed-gas preparation system as claimed in claim 5, wherein the filter device and the heating device are arranged in the supply station.

18. The compressed-gas preparation system as claimed in claim 7, wherein the component which moves during operation is an arm of the manipulator.

19. The compressed-gas preparation system as claimed in claim 9, wherein the supply line section has a length of at most 0.5 m.

20. The compressed-gas preparation system as claimed in claim 9, wherein the flow passage of said supply line section is free of any valves and/or pressure reducers.
